(19) United States
(12) Patent Application Publication
(10) Pub. No.: US 2011/0019216 A1
(43) Pub. Date: Jan. 27, 2011

(54) NETWORK MULTIFUNCTIONAL PERIPHERAL

(75) Inventors: Naoto Kataoka, Kyoto-shi (JP); Taku Soneoka, Kyoto-shi (JP); Kazuya Maekawa, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Kyoto-shi (JP)

(21) Appl. No.: 12/833,076

(22) Filed: Jul. 9, 2010

(30) Foreign Application Priority Data
Jul. 24, 2009 (JP) 2009-173429

(51) Int. Cl. G06F 3/12

(52) U.S. Cl. 358/1.13; 358/1.15

(57) ABSTRACT

A network multifunctional peripheral enables a desired access target to be more rapidly specified when a user specifies an access target or a storage destination of the data, and includes a control unit arranged to search a storage destination accessible with a plurality of protocols at a predetermined timing, a backup RAM arranged to store a list of searched and acquired accessible storage destinations (browse list), an operation unit arranged to accept an operation from the user, and a display unit arranged to display the browse list stored in the backup when an operation requesting a process involving a specification of the storage destination, for example, an operation such as “scan to CIFS” is accepted.

### CROSS-REFERENCE TO RELATED APPLICATIONS

This application claims priority under 35 U.S.C. 119 to Japanese Patent Application No. 2009-173429, filed on Jul. 24, 2009, which application is hereby incorporated by reference in its entirety.

### BACKGROUND OF THE INVENTION

1. Field of the Invention

The present invention relates to a network multifunctional peripheral.

2. Description of the Related Art

In recent years, some multifunctional peripherals have included a function of transferring and storing a scanned image to a shared folder on a network (scan to folder function). A protocol used by a multifunctional peripheral and a protocol used by a device at a transfer destination need to be matched in order to transfer the scanned image data via the network.

There is known a technique that enables data to be transferred and stored by simply specifying the shared folder of the storage destination without a user being conscious of the protocol when storing data to the shared folder. When an instruction to store the data is made by the user, “Server Message Block (SMB)” is first set for the protocol from a plurality of protocols, and transfer is made to a file server including the shared folder by the SMB protocol. The data is transferred according to the SMB if a response is provided by the file server, which is the transfer destination. If a response is not provided by the transfer destination, a different protocol (e.g., “File Transfer Protocol (FTP)”) is set for the protocol, and data transfer by such a protocol is executed. As transfers by different protocols are sequentially attempted automatically when transferring and storing the image data in the shared folder via the network, the file can be transferred and stored by simply specifying the folder of the storage destination without the user being conscious of the protocol.

When a user specifies a shared folder of a storage destination, a list of accessible shared folders is often presented to the user. When searching for the shared folder and the like of a file server and a computer on an accessible network with respect to all protocols, to which the multifunctional peripheral corresponds, upon presenting the accessible shared folders to the user, it sometimes takes a long time until a search result is presented. As a result, it may take a long time until the user selects and specifies the shared folder of the storage destination.

### SUMMARY OF THE INVENTION

In order to overcome the problems described above, preferred embodiments of the present invention provide a network multifunctional peripheral enabling a desired access target to be more rapidly specified when the user specifies the access target that is the storage destination of the data.

A network multifunctional peripheral according to a preferred embodiment of the present invention includes: a search unit arranged to search an accessible storage destination at a predetermined timing; a storage unit arranged to store the accessible storage destination searched by the search unit; an input unit arranged to accept an operation from a user; and a display unit arranged to display the accessible storage destination stored in the storage unit when an operation requesting a process involving a specification of the storage destination is accepted by the input unit.

According to the network multifunctional peripheral of a preferred embodiment of the present invention, the accessible storage destinations are searched and stored in advance. The stored storage destinations are displayed when the processing request involving the specification of the storage destination is accepted. Thus, since the search for the accessible storage destinations is completed when the operation requesting the process involving the specification of the storage destination is accepted, the storage destinations can be rapidly displayed. As a result, the time until specifying the desired access target that is the storage destination can be reduced. The storage destination includes not only the destination for the network multifunctional peripheral to transmit the data, but also a transmission source in a case of receiving the data. For example, the storage destination includes a folder, a computer including the folder, a domain/work group to which the computer belongs, and the like. The storage destination also preferably includes a built-in storage of the multifunctional peripheral and a USB memory connected to the multifunctional peripheral. The process involving the specification of the storage destination includes “scan to folder”, “scan to USB memory”, and “Print On Demand” process of reading and printing out the stored data.

In the network multifunctional peripheral according to a preferred embodiment of the present invention, the search unit preferably searches for the accessible storage destination for every protocol with respect to a plurality of protocols. In this case, the accessible storage destinations are searched and stored in advance for every plurality of different protocols, and displayed upon request. The user thus can specify the storage destination without being conscious of the protocol even if the protocol adopted by the storage destination is different.

Herein, the plurality of protocols preferably includes CIFS (Common Internet File System) and HTTP (Hypertext Transfer Protocol). Accordingly, the CIFS (Server Message Block (SMB)) and the HTPP, which are the main protocols, are compatible, and numerous network devices adopting such protocols can be accessed.

In the network multifunctional peripheral according to a preferred embodiment of the present invention, the input unit preferably accepts authentication information from the user; and the search unit preferably searches for the accessible storage destination based on the authentication information. Accordingly, the storage destination related to the authentication information of the user can be searched. The storage destination assumed to have high relevance with the user can be efficiently searched.

Moreover, the search unit preferably searches for the accessible storage destination based on a character string contained in the authentication information. Accordingly, the storage destination including, in the device name or the pass name, the character string (e.g., user name and the like) contained in the authentication information can be searched. The storage destination having a high possibility of being desired by the user can be accurately searched and presented.

Moreover, in the network multifunctional peripheral according to a preferred embodiment of the present invention, the display unit preferably sets a priority of the storage destinations to display based on the character string contained in the authentication information, and displays the accessible storage destination according to the priority. Accordingly, the storage destination including, in the device name or the pass name, the character string (e.g., user name) contained in the authentication information can be preferentially displayed. The storage destination having a high relevance with the user, that is, the storage destination having a high possibility of being desired by the user thus can be preferentially displayed.

In the network multifunctional peripheral according to a preferred embodiment of the present invention, the storage unit preferably stores a history of the storage destination specified by the user for every authenticated user; and the display unit preferably preferentially displays the storage destination, which history is stored, for every authenticated user. Generally, the storage destination specified previously has a high possibility of being specified again. In this case, the history of the storage destination specified by the user is stored, and the storage destination specified previously by the user is preferentially displayed based on the history. Thus, the storage destination having a high possibility of being specified again can be preferentially displayed for every user.

In the network multifunctional peripheral according to a preferred embodiment of the present invention, the input unit preferably accepts an input of a character string; and the search unit preferably searches for the accessible storage destination based on the accepted character string. In this case, a keyword or the like of the storage destination to search is inputted as the character string, and the storage destination can be searched according to the keyword. Thus, the user can efficiently search for the storage destination the user is looking for.

Moreover, in the network multifunctional peripheral according to a preferred embodiment of the present invention, the search unit preferably searches for the storage destination containing a character string that matches the inputted character string in unique information. Therefore, the storage destination including the character string that matches the inputted character string in the unique information specifying the storage destination such as the device name and the pass name can be specified and searched. The user thus can efficiently search for the storage destination the user is looking for.

In the network multifunctional peripheral according to a preferred embodiment of the present invention, the input unit preferably accepts a storage destination to exclude from a search result searched by the search unit; and the display unit preferably displays the accessible storage destination with the accepted excluding storage destination excluded therefrom. Therefore, the unnecessary storage destinations can be deleted from the display screen. The number of candidates of the storage destination to display can be reduced, so that the target storage destination can be easily found.

In the network multifunctional peripheral according to a preferred embodiment of the present invention, the input unit preferably accepts an operation of setting information related to the specified storage destination as a shortcut; the storage unit preferably stores the accepted shortcut; and the display unit preferably preferentially displays the stored shortcut when the operation requesting the process involving the specification of the storage destination is accepted by the input unit. Accordingly, the information related to the storage destination such as the storage destination name, the pass, and the protocol are stored as shortcut, and the shortcut is displayed when the operation requesting the process involving the specification of the storage destination is accepted. The user thus can more easily specify the target storage destination.

In the network multifunctional peripheral according to a preferred embodiment of the present invention, the search unit preferably checks for a presence of the storage destination stored in the storage unit when the operation requesting the process involving the specification of the storage destination is made through the input unit; and the display unit preferably displays the storage destination, which presence is checked by the search unit. For example, the communication terminal in the communication area sometimes changes with time in a wireless LAN. According to the network multifunctional peripheral of a preferred embodiment of the present invention, the presence of the stored storage destination is checked when transferring the data, and thus the specification of the storage destination, the transfer of the data, and the like can be reliably performed.

The network multifunctional peripheral according to a preferred embodiment of the present invention preferably includes an access unit arranged to transfer data with a storage destination specified by the user; wherein the storage unit stores one or more protocols usable with respect to the storage destination for every searched accessible storage destination; and when a plurality of protocols usable with respect to the storage destination to be accessed is stored in the storage unit, the access unit selects and uses one of the protocols of the plurality of protocols. Accordingly, even if a plurality of protocols is usable, the user can transfer data with the storage destination by simply specifying the storage destination without being conscious of the protocol.

Moreover, in the network multifunctional peripheral according to a preferred embodiment of the present invention, the access unit preferably transfers data with the protocol switched to another protocol stored in the storage unit when the data cannot be transferred with the selected protocol. Thus, even if trouble occurs in the communication using a certain protocol, the protocol can be automatically switched to another usable protocol. The user thus can reliably execute the data transfer without switching the protocol.

A network multifunctional peripheral according to a preferred embodiment of the present invention includes an input unit arranged to accept an operation from a user; a storage unit arranged to store a history of storage destinations specified previously; a display unit arranged to display storage destinations specified previously based on the history stored in the storage unit when an operation requesting a process involving specification of the storage destination is accepted by the input unit; and a search unit arranged to start a search of an accessible storage destination after the storage destination specified previously is displayed by the display unit. As described above, the storage destination specified previously generally has a high possibility being specified again. In this case, the history of the storage destination specified previously is stored, and the storage destination specified previously is displayed based on the history. The search for the storage destination newly starts thereafter. The storage destination having a high possibility of being specified again thus can be displayed first, and the next search result can be acquired while looking for the target storage destination from the displayed storage destinations even if the storage destination desired by the user is not in the storage destinations displayed first. Therefore, the user can continue to look for the target storage destination without waiting.

Herein, the storage unit preferably stores the history of the storage destinations specified previously for every authenticated user; and the display unit preferably displays the storage destinations specified previously based on the history stored in the storage unit for every authenticated user. In this case, the history of the storage destination specified previously by the user is stored, and the storage destination specified previously by the user is displayed based on the history. The storage destination having a high possibility of being specified again can be displayed first (before start of search) for every user.

A network multifunctional peripheral according to a preferred embodiment of the present invention includes an input unit arranged to accept an operation from a user; a search unit arranged to search and output an accessible storage destination when an operation requesting a process involving specification of the storage destination is accepted from the user through the input unit; and a display unit arranged to sequentially display the accessible storage destination outputted from the search unit. According to the network multifunctional peripheral of a preferred embodiment of the present invention, the search and the display of the search result are performed in parallel. Therefore, the user can look for and specify the target storage destination from the sequentially displayed search results without waiting for the search to be completely finished.

In the network multifunctional peripheral according to a preferred embodiment of the present invention, the search unit preferably searches for the accessible storage destination for a predetermined time, once outputs a search result to the display unit, and thereafter continues the search. In this case, the search for the accessible storage destinations is performed for a predetermined time, the search results are displayed, and then the search is further continued. Thus, the user can look for the target storage destination from the once displayed search results without waiting for the search to be completely finished. The next search result can be acquired while looking for the target storage destination from the displayed storage destinations even if the storage destination desired by the user is not in the search results displayed first. Therefore, the user can continue to look for the target storage destination without waiting for a long time.

In the network multifunctional peripheral according to a preferred embodiment of the present invention, the input unit preferably accepts an operation of updating the display of the storage destination; and the display unit preferably updates the display of the accessible storage destination when the operation of updating the display of the storage destination is accepted. Accordingly, the display can be made while sequentially switching from a higher level hierarchy to a lower level hierarchy by updating the display of the search results of the storage destinations.

According to various preferred embodiments of the present invention, the user can more rapidly specify the desired access target when specifying the access target that is the storage destination of the data.

The above and other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating an overall configuration of a network multifunction peripheral according to a preferred embodiment of the present invention.

FIG. 2 is a flowchart illustrating a processing procedure of a browse list acquiring process by the network multifunctional peripheral according to a preferred embodiment of the present invention.

FIG. 3 is a flowchart illustrating a processing procedure of a browse list display process by the network multifunctional peripheral according to a preferred embodiment of the present invention.

FIG. 4 is a view illustrating a display example of a list of domain/work groups.

FIG. 5 is a view illustrating a display example of a list of computer names.

FIG. 6 is a view illustrating a display example of a list of computer names in which logged in users are preferentially displayed.

FIG. 7 is a flowchart illustrating a processing procedure of a shortcut registration process by the network multifunctional peripheral according to a preferred embodiment of the present invention.

FIG. 8 is a flowchart illustrating a processing procedure of a shortcut execution process by the network multifunctional peripheral according to a preferred embodiment of the present invention.

FIG. 9 is a flowchart illustrating a processing procedure of a browsing process of sequentially executing browsing by the network multifunctional peripheral according to a preferred embodiment of the present invention.

### DETAILED DESCRIPTION OF PREFERRED EMBODIMENTS

### First Preferred Embodiment

Preferred embodiments of the present invention will be described below in detail with reference to the drawings. The same reference numerals are denoted for the same elements throughout the figures.

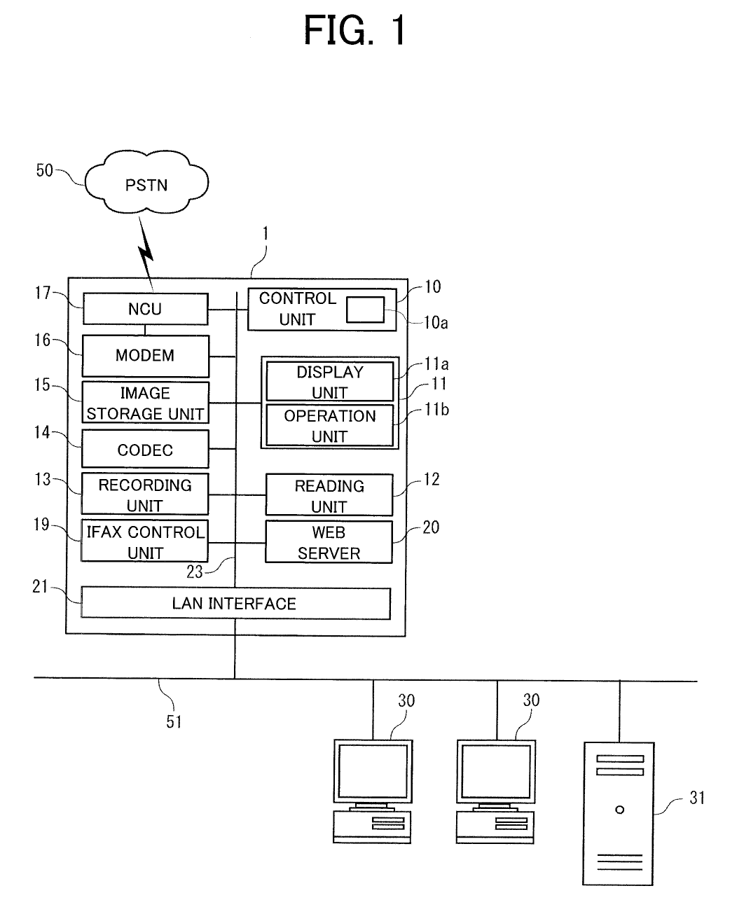

First, a configuration of a network multifunctional peripheral (MFP) 1 according to a preferred embodiment will be described with reference to FIG. 1. FIG. 1 is a block diagram illustrating the configuration of the network multifunction peripheral 1.

The network multifunction peripheral 1 has an Internet FAX (IFAX) function to transmit and receive image data via the Internet using an E-mail in addition to each function of a network compatible scanner, a copier, a printer, and a facsimile (FAX). The network multifunction peripheral 1 also has a function to scan a document and convert the scanned document to digital data, and then transfer the same to various destinations and storage destinations. More specifically, the network multifunction peripheral 1 has a scan to CIFS function to directly transmit the scan data to a shared folder on the network (e.g., a shared folder of a computer 30, a shared folder of a file server 31, and the like); a scan to Web-based Distributed Authoring and Versioning (WebDAV) function to transfer the scan data to the WebDAV server on the Internet; a scan to File Transfer Protocol (FTP) function to transmit the scan data to the FTP server and store the same in a specified folder; a scan to BOX function to store the scan data to a box in a hard disc (HDD) of a main body; and a scan to Universal Serial Bus (USB) memory function to directly store the scan data to an USB memory. The shared folder on the network such as the folder of the computer 30 and the shared folder of the file server 31, the WebDAV server, the FTP server, the hard disc of the main body, the USB memory, and the like correspond to the storage destination.

The network multifunctional peripheral 1 has a browsing function to create a browse list holding a list of storage destinations such as the accessible server and the computer, and to provide the content with respect to a request from the user. As described above, when specifying the storage destination and storing the scan data, the network multifunction peripheral 1 presents the browse list to the user. Processes involving specification of the storage destination in which the browse list is presented include, in addition to the storage destination of the scan data, a Print On Demand process, a process to output the data in the network multifunction peripheral 1 (e.g., journal, log information, counter information, and the like) to the storage destination, a process to copy the data from the storage destination to the USB memory attached to the network multifunctional peripheral 1, and a process to copy the data in the USB memory to the storage destination on the network.

The network multifunction peripheral 1 that implements and performs each function described above preferably includes a control unit 10, a display/operation unit 11, a reading unit 12, a recording unit 13, a codec 14, an image storage unit 15, a modem 16, a Network Control Unit (NCU) 17, an IFAX control unit 19, a Web server 20, an LAN interface 21, and the like. The units are communicably connected to each other with a signal line (bus) 23.

The control unit 10 is preferably configured by a microprocessor to perform calculation, a ROM to store programs and the like to cause the microprocessor to execute each process, a RAM to temporarily store various types of data such as a calculation result, a backup RAM 10a to back up the data, and the like. The control unit comprehensively controls hardware configuring the network multifunctional peripheral 1, and realizes each function of the network multifunction peripheral 1 by executing the program stored in the ROM. The control unit 10 searches for the storage destination such as the server and the computer accessible using a plurality of protocols repeatedly (e.g., everyone hour) at a predetermined timing with the LAN interface 21 described below. In other words, the control unit 10 and the LAN interface 21 function as a search unit.

The list (browse list) of storage destinations such as the searched and acquired accessible servers and computers is stored in the backup RAM 10a of the control unit 10. The backup RAM 10a stores a history of the storage destination the user specified previously for every user. In other words, the backup RAM 10a functions as a storage unit. Furthermore, the control unit 10 also performs authentication of the user using the network multifunctional peripheral 1. The control unit 10 performs the authentication of the user based on whether or not a user ID and a password registered in a password management table stored in the backup RAM 10a and a user ID and a password inputted from the user match.

The display/operation unit 11 preferably is a so-called touch screen, and is an input device configured to include a display unit 11a such as a liquid crystal display (LCD) that is a display device operative to display an operation screen and the like, and an operation unit 11b such as a touch panel arranged to detect a touch operation (input) of the user. The display unit 11a displays the operation state of the network multifunctional peripheral 1, various types of setting information, and various types of keys for operating the network multifunctional peripheral 1 such as a ten key, a speed key, a start key, a stop key, and various types of function keys. The display unit 11a also displays the browse list acquired by the control unit 10. In other words, the display unit 11a functions as the display unit.

The operation unit 11b is arranged to cover the display screen of the display unit 11a, where a two-dimensional coordinate (X-Y coordinate) is virtually arranged on the surface thereof. When the touch operation by the user is made, the operation unit 11b outputs coordinate information corresponding to a touch position. A pressure, an electrostatic capacity, infrared light, an ultrasonic wave, and the like, for example, may be preferably used to detect the touch position. The display unit 11b determines the operation content of the user based on display positions of various types of keys, etc. and the coordinate information indicating the touch position, and outputs the result to the control unit 10. The operation unit 11b accepts the operation by the user such as the operation requesting the scan to CIFS, the scan to WebDAV, the scan to BOX, and the like through the keys. The operation unit 11b accepts the operation to select and specify the server, the computer, or the like that becomes the storage destination when executing such processes. Furthermore, the operation unit 11b accepts an input operation of authentication information of the user (e.g., user name, user ID, and the like), a search keyword (character string), and the like. In other words, the operation unit 11b functions as an input unit.

When scanning the document to generate image data, and saving the same in the shared folder of the file server 31, the user first sets the document, and operates the function key and the like to call out the scan to CIFS function. The user then selects and specifies the shared folder of the file server 31 as the storage destination for storing the scan data from the displayed browse list, and pushes the start key. Through such series of operations, the document is scanned to generate the image data, and the generated image data is transferred to and stored in the shared folder of the file server 31.

The reading unit 12 is preferably configured by a light source, a CCD, and the like, for example, and reads a document such as a paper document for every line according to the set sub-scanning line density, and generates the image data. The image data generated by the reading unit 12 is outputted to the recording unit 13, the codec 14, or the storage destination specified by the user according to the requested process. The recording unit 13 preferably is a printer using an electrophotographic method, and for example, the recording unit 13 prints out print data received from an external personal computer, the image data read by the reading unit 12, the image data received by facsimile, and the like on paper.

The codec 14 codes and compresses (hereinafter also simply referred to as “coding”) the image data read by the reading unit 12, and also decodes the coded image data. The image storage unit 15 is preferably configured by a DRAM and the like, and stores the image data coded in the codec 14, the image data received by facsimile, and the like.

The modem (modulator/demodulator) 16 performs modulation and demodulation between a digital signal and an analog signal. The modem 16 generates and detects various types of functional information such as a digital command signal (DCS). The NCU 17 is connected to the modem 16, and controls a connection of the modem 16 and a public switched telephone network (PSTN) 50. The NCU 17 also has a function to send a call indication signal corresponding to a facsimile number transmitting destination, and detect the incoming call thereof.

The IFAX control unit 19 is responsible for the IFAX function using the Internet environment. The IFAX control unit 19 has a function to transmit an E-mail according to a Simple Mail Transfer Protocol (SMTP) and a function to receive an E-mail according to a Post Office Protocol (POP). The IFAX control unit 19 attaches the transmitting document to the E-mail as image data of TIFF format and the like, and transmits the same to the E-mail address destination. The IFAX control unit 19 receives the E-mail from the POP server every set time, and prints out the attached file. The Web server 20 enables access from a client terminal to execute a predetermined HTTP task with respect to data such as a homepage described with HTML, a login page, and a facsimile operation page.

The LAN interface 21 is a network interface arranged to perform a transmission/reception control process of various types of protocols, and a data analyzing process and a data creating process on the various types of protocols. The LAN interface 21 is connected to the LAN 51, and transmits signals and data to the LAN 51. The LAN interface 21 transfers data with the storage destination specified by the user when the scan to CIFS process or the like is executed. In this case, if there are a plurality of protocols that can be used with respect to the storage destination to be accessed, the LAN interface 21 selects and uses one of the plurality of protocols. However, if the data cannot be transferred by the selected protocol, the data is transferred with the protocol switched to another stored protocol. In other words, the LAN interface 21 functions as an access unit.

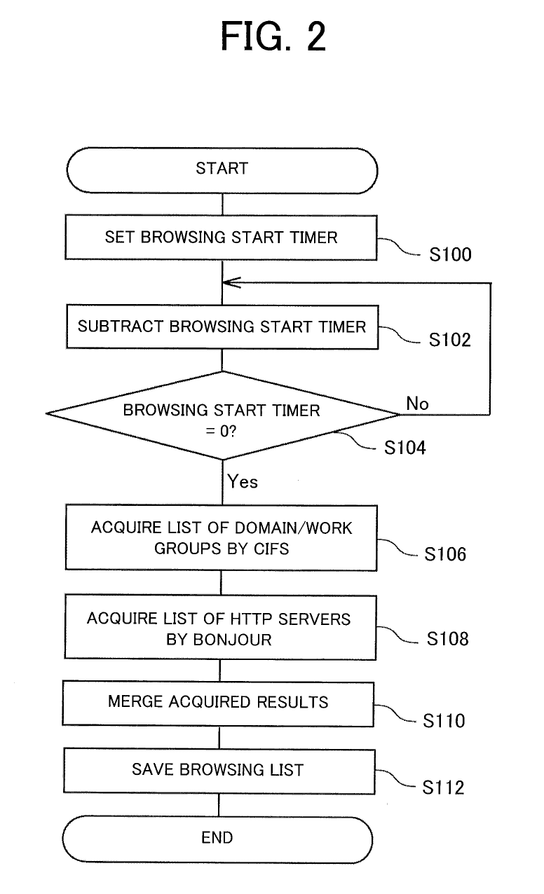

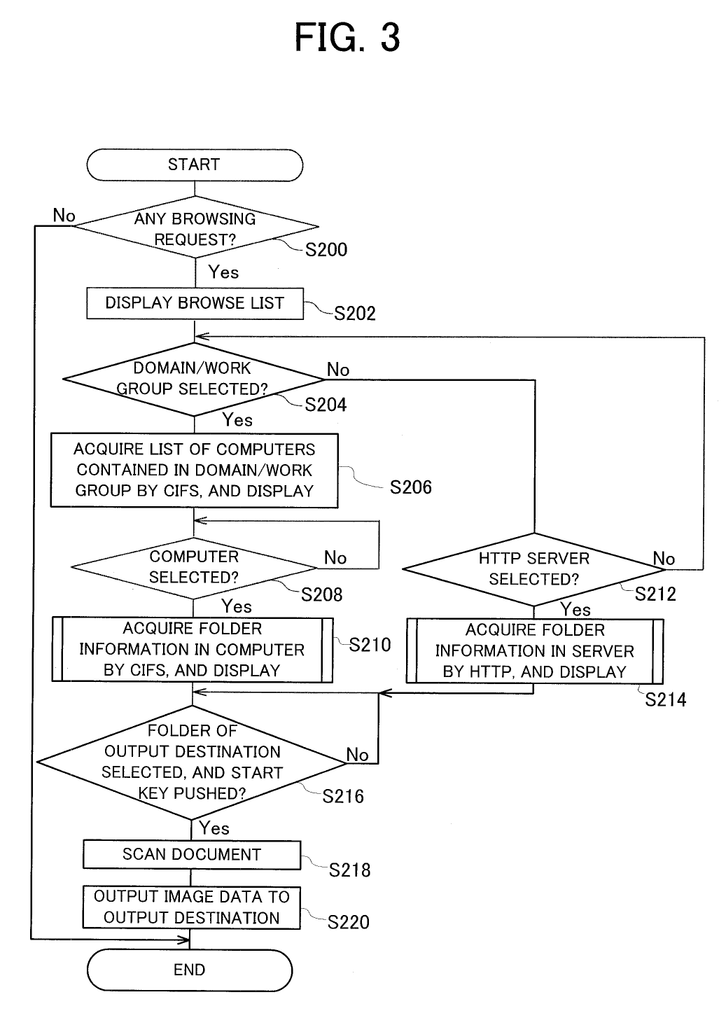

A browsing process by the network multifunctional peripheral 1 will be described below with reference to FIGS. 2 and 3. FIG. 2 is a flowchart illustrating a processing procedure of a browse list acquiring process by the network multifunctional peripheral 1. FIG. 3 is a flowchart illustrating a processing procedure of a browse list display process by the network multifunctional peripheral 1. The browse list acquiring process illustrated in FIG. 2 is repeatedly executed at a predetermined timing in the background. The browse list display process illustrated in FIG. 3 is activated and executed when the operation requesting the process involving the specification of the storage destination (e.g., scan to CIFS, scan to BOX and the like) is accepted.

The browse list acquiring process will be described first with reference to FIG. 2. In step S100, a browsing start timer defining a cycle (e.g., one hour) for executing browsing of searching the accessible storage destination is set. In the following step S102, the browsing start timer set in step S100 is subtracted. In the following step S104, whether or not the value of the browsing start timer is zero, that is, whether or not the timing to search for the accessible storage destination and acquire the browse list is determined. If the timer value is zero, the process proceeds to step S106. If the timer value is not zero, the process proceeds to step S102, and the above processes of steps S102, S104 are repeatedly executed until the timer value becomes zero.

If the value of the browsing start timer is zero, in step S106, a list of accessible domain/work groups on the network is acquired by the CIFS or the protocol extended from the SMB. Subsequently, in step S108, a list of accessible HTTP servers on the network is acquired by Bonjour. When acquiring the list of accessible domain/work groups and the list of the HTTP servers, the search may be performed in view of the character string such as the user ID of the user logged into the network multifunctional peripheral 1, the user name (authentication information), or the keyword inputted by the user. More specifically, the domain/work group and the HTTP server in which the character string that matches (full match or partial match) the character string such as the user ID, the user name, and the keyword is contained in the unique information for specifying the domain/work group or the HTTP server such as the device name and the pass name may be searched.

In step S110, the list of domain/work groups acquired in step S106 and the list of HTTP servers acquired in step S108 are merged to generate the browse list. In the following step S112, the browse list generated in step S110 is saved in the backup RAM 10a of the control unit 10. The present process is thereafter once terminated.

The browse list display process will now be described with reference to FIG. 3. In step S200, whether or not the operation requesting the process involving the specification of the server or the computer, which becomes the storage destination, such as the scan to CIFS and the scan to BOX is accepted, that is, whether or not the browse list needs to be displayed is determined. If determined that the browse list needs to be displayed, the process proceeds to step S202. If determined that the browse list does not need to be displayed, the present process is once terminated.

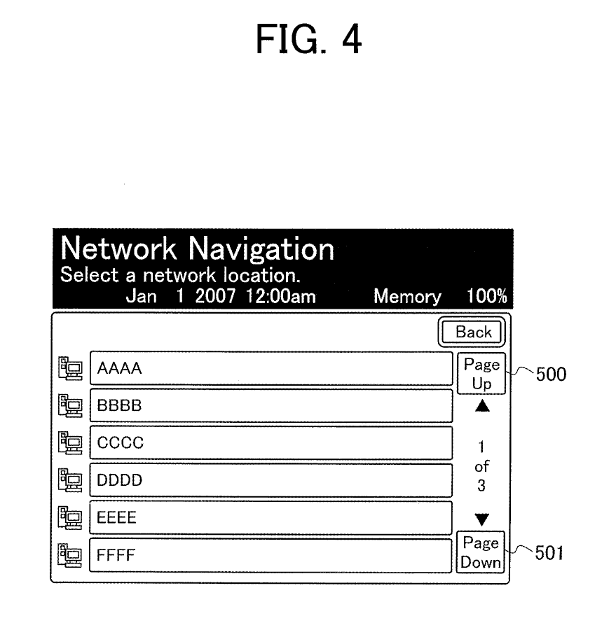

If determined that the browse list needs to be displayed, the browse list stored in the backup RAM 10a, that is, the list of accessible domain/work groups and HTTP servers is displayed by the display unit 11a in step S202. A display example of the list of domain/work groups is illustrated in FIG. 4.

Thereafter, in step S204, whether or not the domain/work group is selected from the displayed browse list is determined. If the domain/work group is selected, the process proceeds to step S206. If the domain/work group is not selected, the process proceeds to step S212.

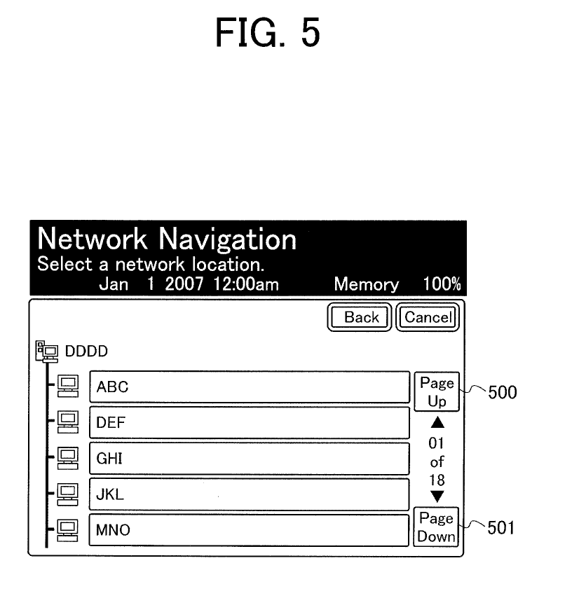

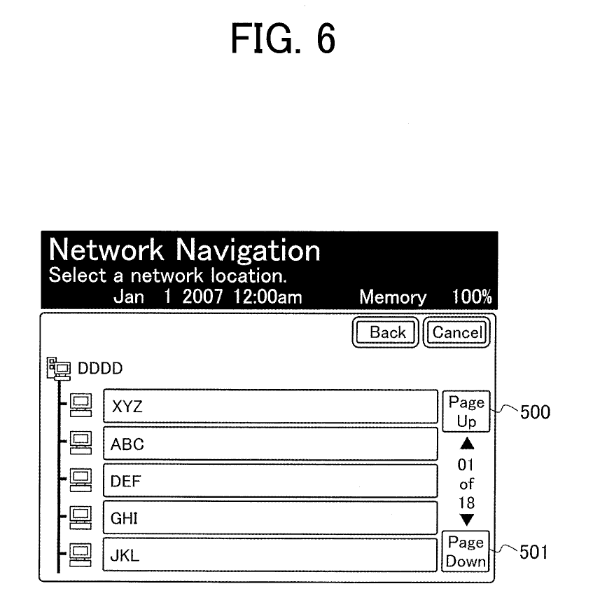

In step S206, a list of computers belonging to the selected domain/work group is acquired by the CIFS and displayed. A display example of the list of computer names is illustrated in FIG. 5. When displaying the list of domain/work groups, the list of computers belonging to the domain/work group, and the list of HTTP servers, the display may be made in view of the character string such as the user ID of the logged in user, the user name (authentication information), or the keyword inputted by the user. More specifically, the character string such as the user ID, the user name, and the keyword may be compared with the domain group and the computer name obtained as a result of browsing, and the matching ones (full match or partial match) may be preferentially displayed (at high level). A display example of a list of computer names contained in the work group “DDDD” when the user “XYZ” is logged in is illustrated in FIG. 6. In this example, “XYZ” is displayed at the highest level of the first page of the display screen having a total of 18 pages. The history of the domain/work group, computer and the like accessed previously may be stored for every login user, and the stored ones or those with high access frequency may be preferentially displayed. The display page of the browse list can be updated by touching a “Page Up” button 500 and a “Page Down” button 501 illustrated in FIGS. 5 and 6. The display thus can be made while sequentially switching from the higher level hierarchy to the lower level hierarchy of the list.

Returning back to FIG. 3, in step S208, a determination is made at to whether or not the target computer is selected from the list of displayed computers. If the target computer is selected, the process proceeds to step S210. If the target computer is not yet selected, the present step S208 is repeatedly executed until the target computer is selected.

If the target computer is selected, the folder information in the relevant computer is acquired by the CIFS and displayed in step S210. The process then proceeds to step S216.

If the domain/work group is not selected in step S204, whether or not the HTTP server is selected from the displayed browse list is determined in step S212. If the HTTP server is selected, the process proceeds to step S214. If the HTTP server is not selected, the process proceeds to step S204, and step S204 is again executed.

If the HTTP server is selected, the folder information in the HTTP server is acquired and displayed in step S214. The process then proceeds to step S216.

In step S216, the folder of the output destination is selected, and whether or not the start key is pushed is determined. If the folder is selected and the start key is pushed, the process proceeds to step S218. If the folder is not selected and/or the start key is not pushed, the present step is repeatedly executed until the folder is selected and the start key is pushed.

If positive determination is made in step S216, the set document is scanned in step S218. In the following step S220, the scan data is transferred to and stored in the specified folder. Thereafter, the present process is once terminated.

According to the present preferred embodiment, the accessible domain/work groups and the HTTP servers (storage destinations) are searched and stored in advance in the background. The stored storage destinations are displayed when the processing request involving the specification of the storage destination is accepted. Thus, since the search for the accessible storage destinations is completed when the operation requesting the process involving the specification of the storage destination is accepted, the storage destinations can be rapidly displayed. As a result, the time until specifying the desired access target (storage destination) can be reduced.

According to the present preferred embodiment, the HTTP server is searched by the Bonjour after the domain/work group is searched by the CIFS. Both search results are merged and stored, and the stored browse list is displayed when the process involving the display of the browse list is requested. Thus, even if the protocol adopted by the storage destination is different, the user can transfer data, and the like by simply selecting and specifying the target storage destination from the displayed storage destinations without being conscious of the protocol. According to the present preferred embodiment, since the CIFS (SMB) and the HTPP, which are the main protocols, are compatible, numerous network devices adopting such protocols can be accessed.

According to the present preferred embodiment, when acquiring or displaying the list of accessible domain/work groups and the list of HTTP servers, the storage destination including, in the unique information such as the device name and the pass name, the character string contained in the authentication information and the keyword can be searched by carrying out the search in view of the character string such as the user ID of the user logged into the network multifunctional peripheral 1, the user name (authentication information), or the keyword inputted by the user. Therefore, the storage destination having a high possibility of being desired by the user can be efficiently and accurately searched and presented.

According to the present preferred embodiment, the storage destination including, in the device name and the pass name, the character string contained in the authentication information (e.g., user name and the like) can be preferentially displayed by displaying the accessible storage destination according to the priority set based on the character string contained in the user ID of the user logged into the network multifunctional peripheral 1 and the user name (authentication information). Therefore, the storage destination having high relevance with the user, that is, the storage destination having a high possibility of being desired by the user can be preferentially displayed.

According to the present preferred embodiment, the history of the storage destination specified previously by the user is stored for every authenticated user, and the storage destination, which history is stored, is preferentially displayed for every authenticated user when the display of the browse list is requested, so that the storage destination having a high possibility of being specified can be preferentially displayed.

The storage destinations to be excluded from the search result (browse list) may be registered in advance, and the browse list may be displayed excluding such storage destinations when displaying the browse list. The unnecessary storage destinations thus can be deleted from the display screen. The number of candidates of the storage destination to display can be reduced, so that the target storage destination can be easily found.

When the display of the browse list is requested, the presence of the storage destination stored in the backup RAM 10a may be checked, and only the storage destination which presence is confirmed may be displayed. The communication terminal in the communication area sometimes changes with time in the wireless LAN. The USB memory may be removable. Therefore, the configuration of checking the presence of the storage destination when the display of the browse list is requested allows the specification of the storage destination, the transfer of the data, and the like to be reliably performed.

In the preferred embodiment described above, the list of domain/work groups and the list of HTTP servers are preferably acquired and stored in the background, but the computer belonging to the domain/work group as well as the folder information in the computer and the folder information in the HTTP server may also be acquired and stored in advance in the background.

In the first preferred embodiment described above, the browse list is preferably acquired and stored in the background, and the browse list is displayed when the operation requesting the process involving the specification of the folder of the server or the computer, which becomes the storage destination, is accepted.

### Second Preferred Embodiment

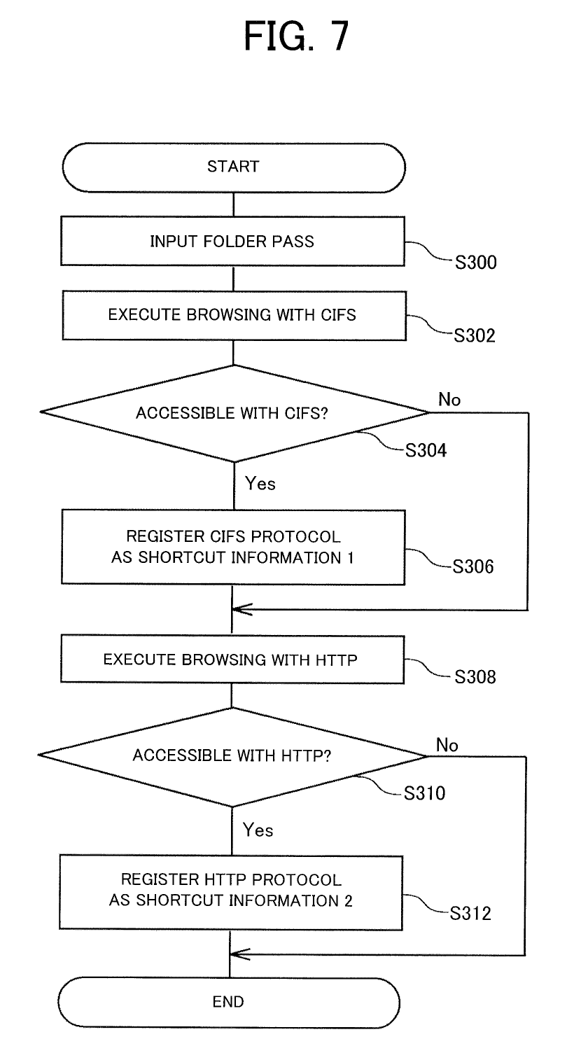

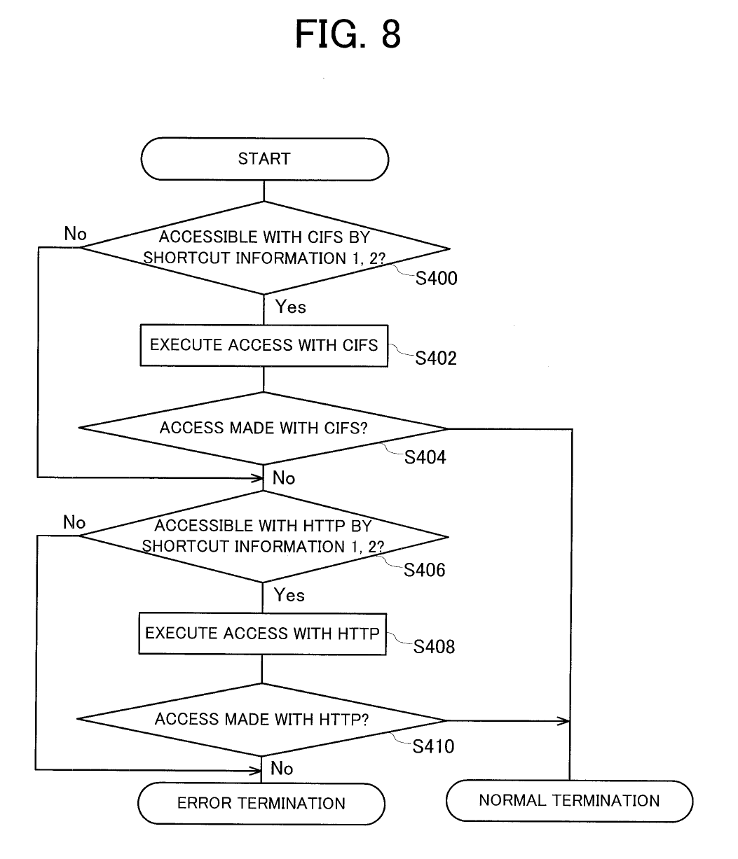

If a certain folder can be accessed by a plurality of protocols, protocol information thereof may be registered as shortcut information, and the shortcut information may be displayed in place of or in addition to the browse list. A shortcut registration process and a shortcut execution process will be described with reference to FIGS. 7 and 8. FIG. 7 is a flowchart illustrating a processing procedure of the shortcut registration process by the network multifunctional peripheral 1. FIG. 8 is a flowchart illustrating a processing procedure of the shortcut execution process by the network multifunctional peripheral 1. The shortcut execution process is activated and executed when the folder of the output destination is specified by the user.

The shortcut registration process will be described first with reference to FIG. 7. In step S300, a pass input for specifying the folder to perform the shortcut registration is accepted. In step S302, the browsing by the CIFS is executed with respect to the folder specified by the pass inputted in step S300. In step S304, whether or not access can be made with the CIFS is determined. If access can be made with the CIFS, the process proceeds to step S306. If access cannot be made with the CIFS, the process proceeds to step S308.

If access can be made with the CIFS, the CIFS protocol is registered as shortcut information 1 of the folder, and saved in the backup RAM 10a in step S306. Thereafter, the process proceeds to step S308.

In step S308, the browsing by the HTTP is executed with respect to the folder specified by the pass inputted in step S300. In step S310, whether or not access can be made with HTTP is determined. If access can be made with the HTTP, the process proceeds to step S312. If access cannot be made with the HTTP, the present process is terminated.

If access can be made with the HTTP, the HTTP protocol is registered as shortcut information 2 of the folder, and saved in the backup RAM 10a in step S312. Thereafter, the present process is terminated.

The shortcut execution process will now be described with reference to FIG. 8. In step S400, the shortcut information 1 and the shortcut information 2 saved in the backup RAM 10a are read, and whether or not the target folder can be accessed with the CIFS is determined based on such shortcut information 1, 2. If access can be made with the CIFS, the process proceeds to step S402. If access cannot be made with the CIFS, the process proceeds to step S406.

If access can be made with the CIFS, the access by the CIFS is executed in step S402. In the following step S404, whether or not access is made by the CIFS is determined. If access is made with the CIFS, the present process is normally terminated. If access is not made with the CIFS, the process proceeds to step S406.

In step S406, whether or not the target folder can be accessed with the HTTP is determined based on the shortcut information 1, 2. If access can be made with the HTTP, the process proceeds to step S408. If access cannot be made with the HTTP, the present process is terminated with an error.

If access can be made with the HTTP, the access by the HTTP is executed in step S408. In the following step S410, whether or not access is made by the HTTP is determined. If access is made with the HTTP, the present process is normally terminated. If access is not made with the HTTP, the present process is terminated with an error.

According to the present preferred embodiment, the information related to the folder such as the folder name, the pass, and the protocol are stored as a shortcut, and displayed when the operation requesting the process involving the specification of the folder is accepted. The user thus can more easily specify the target folder.

According to the present preferred embodiment, even if a plurality of protocols can be used with respect to one folder (storage destination), the user can transfer data with the folder by simply specifying the folder without being conscious of the protocol since the shortcut can be registered for every protocol.

Furthermore, according to the present preferred embodiment, the data is transferred with the protocol switched to another stored protocol if the data cannot be transferred with the selected protocol. Thus, even if trouble occurs in the communication using a certain protocol, the protocol can be automatically switched to another usable protocol. The user thus can reliably execute the data transfer without switching the protocol.

### Third Preferred Embodiment

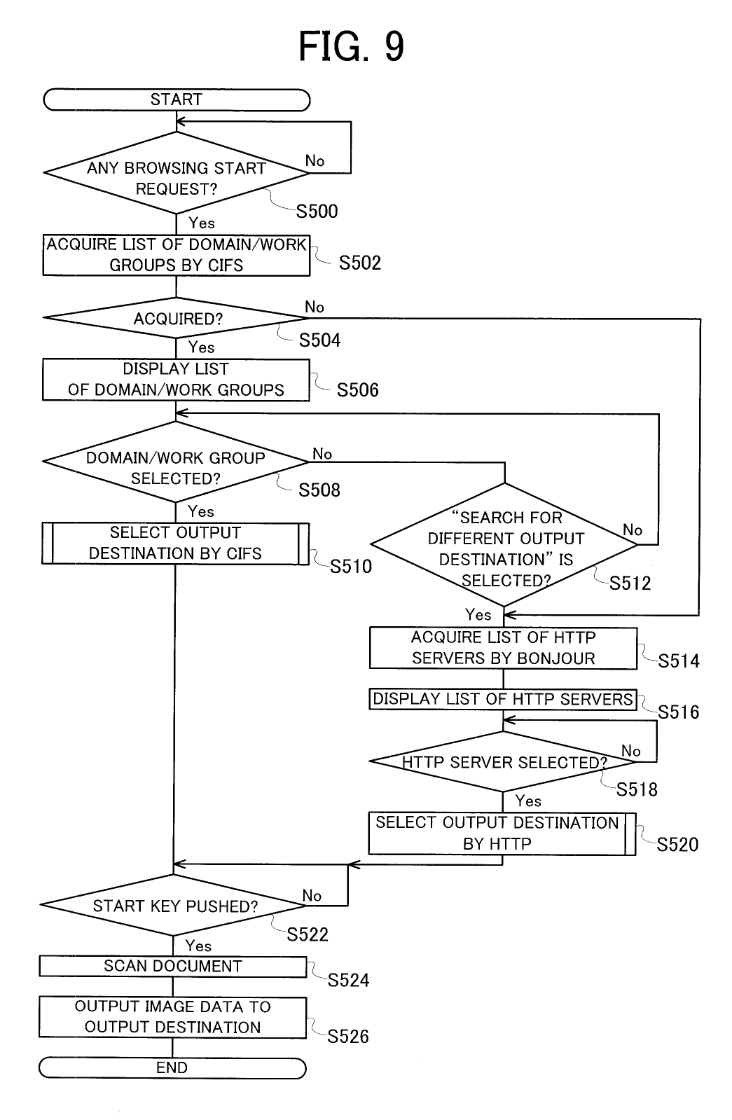

The priority is determined in advance with respect to the protocol to use, where browsing may be performed according to such priority and the results may be sequentially displayed. For example, the domain or the work groups may be listed up with the CIFS, and the HTTP server may be searched with the Bonjour if the target output destination is not included in the relevant list. The browsing process of sequentially executing the browsing will be described with reference to FIG. 9. FIG. 9 is a flowchart illustrating a processing procedure of the browsing process of sequentially executing the browsing by the network multifunctional peripheral 1.

In step S500, whether or not the operation requesting the process involving the specification of the server or the computer that becomes the transfer destination such as scan to CIFS and scan to BOX is accepted, that is, whether or not there is a need to display the browse list is determined. If it is determined that there is a need to display the browse list, the process proceeds to step S502. If it is determined that there is no need to display the browse list, the present process is repeatedly executed until the request to display the browse list is made.

In step S502, a list of accessible domain/work groups on the network is acquired by the CIFS. In the following step S504, whether or not the list of domain/work groups is acquired is determined. If the list of domain/work groups is acquired, the acquired list of domain/work groups is displayed in step S506. The process then proceeds to step S508. If the list of domain/work groups is not acquired, the process proceeds to step S514.

In step S508, whether or not the target domain/work group is selected from the displayed list is determined. If the domain/work group is selected, the process proceeds to step S510. If the domain/work group is not selected, the process proceeds to step S512.

In step S510, the list of computers belonging to the selected domain/work group is displayed, and the folder information in the computer selected from the displayed computers is acquired and displayed. The folder that becomes the output destination is selected by the user from the displayed folder information. The process thereafter proceeds to step S522.

If the domain/work group is not selected, whether or not “search for different output destination” is selected is determined in step S512. If “search for different output destination” is selected, the process proceeds to step S514. If “search for different output destination” is not selected, the process returns to step S508, and step S508 is again executed.

In step S514, the list of accessible HTTP servers on the network is acquired by the Bonjour. In the following step S516, the list of HTTP servers acquired in step S514 is displayed. In step S518, whether or not the HTTP server is selected is determined. If the HTTP server is selected, the process proceeds to step S520. If the HTTP server is not selected, the present step is again executed until the HTTP server is selected.

If the HTTP server is selected, the folder information in the HTTP server is acquired and displayed, and the folder of the output destination is selected by the user in step S520. The process then proceeds to step S522.

In step S522, whether or not the start key is pushed is determined. If the start key is pushed, the process proceeds to step S524. If the start key is not pushed, the present step is repeatedly executed until the start key is pushed.

If positive determination is made in step S522, the set document is scanned in step S524. In the following step S526, the scan data is transferred to and stored in the specified folder. The present process is thereafter terminated once.

According to the present preferred embodiment, the list of domain/work groups is acquired by the CIFS and displayed. If the target output destination is not in the displayed domain/work groups, the list of HTTP servers is acquired by the Bonjour and displayed. The user thus can look for the target output destination without waiting for all of the list of domain/work groups and the list of HTTP servers to be acquired. The priority of the protocol to search for may be set in advance at the time of manufacturing or may be arbitrarily set by the user or a service staff.

A configuration of sequentially displaying from the acquired storage destination when acquiring the list of domain/work groups or the list of HTTP servers, that is, a configuration of performing the search and the display of the search result in parallel may be adopted. In such a case, the user can look for and specify the target storage destination from the sequentially displayed search results without waiting for the search to be completely finished.

When acquiring the list of domain/work groups or the list of HTTP servers, there may be adopted a configuration of searching for the storage destination for a predetermined time and once outputting the search result to the display destination, and then further continuing the search. In such a case, the user can look for the target storage destination from the once displayed search result without waiting for the search to be completely finished. Furthermore, the next search result can be acquired while looking for the target storage destination from the displayed storage destinations even if the storage destination desired by the user is not in the search results (storage destinations) displayed first. Therefore, the user can continue to look for the target storage destination without waiting for a long time.

Moreover, there may be adopted a configuration to store the history of the storage destination specified previously for every authenticated user, and first displaying the storage destinations specified previously by the user based on the history and then newly starting the search for a storage destination. In this manner, the storage destination having a high possibility of being specified again can be displayed first (before start of search) for every user. Furthermore, the next search result can be acquired while looking for the target storage destination from the displayed storage destinations even if the storage destination desired by the user is not in the storage destinations displayed first. The user thus can look for the target storage destination without waiting.

The preferred embodiments of the present invention have been described above, but the present invention is not limited to such preferred embodiments, and various modifications can be made. For example, if compatible to three or more types of protocols, a configuration combining the first preferred embodiment and the third preferred embodiment may be adopted.

While the present invention has been described with respect to preferred embodiments thereof, it will be apparent to those skilled in the art that the disclosed invention may be modified in numerous ways and may assume many preferred embodiments other than those specifically set out and described above. Accordingly, it is intended by the appended claims to cover all modifications of the present invention that fall within the true spirit and scope of the present invention.

What is claimed is:

1. A network multifunctional peripheral comprising:
a search unit arranged to search an accessible storage destination at a predetermined timing;
a storage unit arranged to store the accessible storage destination searched by the search unit;
an input unit arranged to accept an operation request from a user; and
a display unit arranged to display the accessible storage destination stored in the storage unit when an operation requesting a process involving specification of the storage destination is accepted by the input unit.

2. The network multifunctional peripheral according to claim 1, wherein the search unit is arranged to search for the accessible storage destination for each of a plurality of protocols.

3. The network multifunctional peripheral according to claim 2, wherein the plurality of protocols includes CIFS and HTTP.

4. The network multifunctional peripheral according to claim 1, wherein
the input unit is arranged to accept authentication information from the user; and
the search unit is arranged to search for the accessible storage destination based on the authentication information.

5. The network multifunctional peripheral according to claim 4, wherein the search unit is arranged to search for the accessible storage destination based on a character string included in the authentication information.

6. The network multifunctional peripheral according to claim 4, wherein the display unit is arranged to set a priority of the storage destinations to display based on a character string included in the authentication information, and to display the accessible storage destination according to the priority.

7. The network multifunctional peripheral according to claim 4, wherein
the storage unit is arranged to store a history of the storage destination specified by the user for every authenticated user; and
the display unit is arranged to preferentially display the storage destination, which history is stored, for every user.

8. The network multifunctional peripheral according to claim 1, wherein
the input unit is arranged to accept an input of a character string; and
the search unit is arranged to search for the accessible storage destination based on the accepted character string.

9. The network multifunctional peripheral according to claim 8, wherein the search unit is arranged to search for the storage destination including a character string that matches the inputted character string in unique information.

10. The network multifunctional peripheral according to claim 1, wherein
the input unit is arranged to accept a storage destination to exclude from a search result searched by the search unit; and
the display unit is arranged to display the accessible storage destination with the accepted excluding storage destination excluded therefrom.

11. The network multifunctional peripheral according to claim 1, wherein the storage destination includes a built-in storage and a USB memory connected to the network multifunctional peripheral.

12. The network multifunctional peripheral according to claim 1, wherein
the input unit is arranged to accept an operation of setting information related to the specified storage destination as a shortcut;
the storage unit is arranged to store the accepted shortcut; and
the display unit is arranged to preferentially display the stored shortcut when the operation requesting the process involving the specification of the storage destination is accepted by the input unit.

13. The network multifunctional peripheral according to claim 1, wherein
the search unit is arranged to check for a presence of the storage destination stored in the storage unit when the operation requesting the process involving the specification of the storage destination is made through the input unit; and
the display unit is arranged to display the storage destination, which the presence is checked by the search unit.

14. The network multifunctional peripheral according to claim 2, further comprising:
an access unit is arranged to transfer data with a storage destination specified by the user; wherein
the storage unit is arranged to store one or more protocols usable with respect to the storage destination for every searched accessible storage destination; and
when a plurality of protocols usable with respect to the storage destination to be accessed is stored in the storage unit, the access unit selects and uses one of the protocols of the plurality of protocols.

15. The network multifunctional peripheral according to claim 14, wherein the access unit is arranged to transfer data with the protocol switched to another protocol stored in the storage unit when the data cannot be transferred with the selected protocol.

16. A network multifunctional peripheral comprising:
an input unit is arranged to accept an operation from a user;
a storage unit is arranged to store a history of storage destinations specified previously;
a display unit is arranged to display storage destinations specified previously based on the history stored in the storage unit when an operation requesting a process involving a specification of the storage destination is accepted by the input unit; and
a search unit is arranged to start a search of an accessible storage destination after the storage destination specified previously is displayed by the display unit.

17. The network multifunctional peripheral according to claim 16, wherein
the storage unit is arranged to store the history of the storage destinations specified previously for every authenticated user; and
the display unit is arranged to display the storage destinations specified previously based on the history stored in the storage unit for every authenticated user.

18. A network multifunctional peripheral unit comprising:
an input unit is arranged to accept an operation from a user;
a search unit is arranged to search and output an accessible storage destination when an operation requesting a process involving a specification of the storage destination is accepted from the user through the input unit; and
a display unit is arranged to sequentially display the accessible storage destination outputted from the search unit.

19. The network multifunctional peripheral according to claim 18, wherein the search unit is arranged to search for the accessible storage destination for a predetermined time, to once output a search result to the display unit, and thereafter to continue the search.

20. The network multifunctional peripheral according to claim 19, wherein
the input unit is arranged to accept an operation of updating the display of the storage destination; and
the display unit is arranged to update the display of the accessible storage destination when the operation of updating the display of the storage destination is accepted.
